(19) United States
(12) Patent Application Publication
(10) Pub. No.: US 2026/0244585 A1
(43) Pub. Date: Aug. 20, 2026

(54) DATA PROCESSING METHOD AND APPARATUS, DEVICE, AND MEDIUM

(71) Applicant: GUANGDONG INSPUR SMART COMPUTING TECHNOLOGY CO., LTD., Guangzhou, Guangdong (CN)

(72) Inventors: Jingdong ZHANG, Guangzhou, Guangdong (CN); Hongwei KAN, Guangzhou, Guangdong (CN); Jiangwei WANG, Guangzhou, Guangdong (CN); Yanwei WANG, Guangzhou, Guangdong (CN); Rengang LI, Guangzhou, Guangdong (CN); Rui HAO, Guangzhou, Guangdong (CN)

(21) Appl. No.: 19/160,421

(22) PCT Filed: Apr. 24, 2024
(86) PCT No.: PCT/CN2024/089626

§ 371 Date: Aug. 27, 2025

(30) Foreign Application Priority Data
Jun. 9, 2023 (CN) 202310686129.1

(51) Int. Cl. G06F 13/24; G06F 13/40

(52) U.S. Cl. CPC G06F 13/24; G06F 13/4063; G06F 2213/0026

(57) ABSTRACT

The present application relates to the technical field of data processing, and discloses a data processing method and apparatus, a device, and a medium. The method comprises: based on a bus address space allocated for a first slave device, writing data to be processed into a storage component of the first slave device through a first peripheral component interconnect express link, in order that the first slave device processes the data to be processed and obtains result data; obtaining the result data sent by the first slave device; and determining a destination address of the result data, and in response to that the destination address points to a storage space of a second slave device, writing the result data into a storage component of the second slave device through a second peripheral component interconnect express link. The problems of high communication delay and high hardware resource overhead during data transmission exist in the prior art. The present application can reduce cross-node communication delay and hardware resource overhead.

### CROSS-REFERENCE TO RELATED APPLICATION

The present application is the national phase entry of International Application No. PCT/CN2024/089626, filed on Apr. 24, 2024, which claims the priority of Chinese patent application filed in CNIPA on June 9, 2023, with the application number of 202310686129.1 and the application name of “DATA PROCESSING METHOD AND APPARATUS, DEVICE, AND MEDIUM”, the entire contents of which are incorporated into the present application by reference.

### FIELD

The present application relates to the technical field of data processing, in particular to a data processing method, an apparatus, a device and a medium.

### BACKGROUND

At present, communication between GPU (i.e., Graphics Processing Unit) cards and traditional FPGA (i.e., Field Programmable Gate Array) cards across nodes, usually depends on participation of a CPU (i.e., Central Processing Unit), memory and PCIe (i.e., peripheral component interconnect express) Chip set, etc., of server, that is, it needs to use tight couple with the server through a PCIe interface bus, and it is difficult to run independently from a host CPU. In this way, communication delay in a data transmission process is high, and hardware resource overhead thereof is large.

### SUMMARY

In view of the above, the purpose of the present application is to provide a data processing method, an apparatus, a device and a medium, which may reduce communication delay across nodes and the hardware resource overhead thereof, and specific solutions thereof are as follows:

On a first aspect, the present application discloses a data processing method, applied to a master field programmable gate array device, and the data processing method includes:
based on a bus address space allocated for a first slave device, writing data to be processed into a storage component of the first slave device through a first peripheral component interconnect express link, in order that the first slave device processes the data to be processed and obtains result data;
obtaining the result data sent by the first slave device; and
determining a destination address of the result data, and if the destination address points to a storage space of a second slave device, writing the result data into a storage component of the second slave device through a second peripheral component interconnect express link.

In an embodiment of the present application, after based on the bus address space allocated for the first slave device, writing the data to be processed into the storage component of the first slave device through the first peripheral component interconnect express link, the method further includes:
sending an interrupt data packet to notify the first slave device to process the data to be processed.

In an embodiment of the present application, sending the interrupt data packet to notify the first slave device to process the data to be processed includes:
based on a mapping relationship of registers in the first slave device on a bus of the master field programmable logic gate array device, writing the interrupt data packet into a designated register of the first slave device, to notify the first slave device to process the data to be processed.

In an embodiment of the present application, the method further including:
in response to that the destination address points to a storage space of a local device, writing the result data into a local storage component.

In an embodiment of the present application, the method further including:
in response to that the destination address points to a network module of local, sending the result data to the network module and sending the result data to a network by the network module.

In an embodiment of the present application, the method further including:
in response to that the destination address points to an acceleration core module of local, sending the result data to the acceleration core module, and calling a preset processing logic by the acceleration core module to process the result data.

In an embodiment of the present application, the method further including:
determining a data processing type based on a descriptor corresponding to the result data; and
calling the preset processing logic through the acceleration core module to process the result data, includes: calling the preset processing logic corresponding to the data processing type by the acceleration core module to process the result data.

In an embodiment of the present application, calling the preset processing logic corresponding to the data processing type by the acceleration core module to process the result data, includes:
in response to that the data processing type is encryption processing, calling an encryption processing logic through the acceleration core module to encrypt the result data;
in response to that the data processing type is compression processing, calling a compression processing logic through the acceleration core module to compress the result data; and
in response to that the data processing type is the compression processing first and then the encryption processing, calling the compression processing logic to compress the result data to obtain compressed data, and calling the encryption processing logic to encrypt the compressed data, through the acceleration core module.

In an embodiment of the present application, after sending the interrupt data packet to notify the first slave device, the method further includes:
reading the result data from the storage component of the first slave device when a notification sent by the first slave device is obtained;
wherein the result data is stored into the storage component of the first slave device by the first slave device.

In an embodiment of the present application, after reading the result data from the storage component of the first slave device, the method further includes:
caching the result data to a storage component of a local device.

In an embodiment of the present application, the method further including:
compressing the result data by using the acceleration core module to obtain compressed data, and encrypting the compressed data to obtain encrypted data.

In an embodiment of the present application, after encrypting the compressed data to obtain the encrypted data, the method further includes:
encapsulating the encrypted data by using a network module and sending encapsulated encrypted data to other nodes through an optical network.

In an embodiment of the present application, reading the result data from the storage component of the first slave device, includes:
reading the result data from the storage component of the first slave device by using a direct data access engine.

In an embodiment of the present application, the method further including:
finding slave devices in place, and allocating a bus address space for each slave device in place to complete registration of the devices in place; and
allocating bus address spaces for respective local modules.

In an embodiment of the present application, the first slave device is a GPU accelerator card or a field programmable gate array accelerator card, and the second slave device is a GPU accelerator card or a field programmable gate array accelerator card.

In an embodiment of the present application, based on the bus address space allocated for the first slave device, writing data to be processed into the storage component of the first slave device through the first peripheral component interconnect express link, includes:
obtaining data to be processed from a network, and if the data to be processed is encrypted data, decrypting the data to be processed to obtain decrypted data; and
based on the bus address space allocated for the first slave device, writing the decrypted into the storage component of the first slave device through the first peripheral component interconnect express link.

In an embodiment of the present application, based on the bus address space allocated for the first slave device, writing data to be processed into the storage component of the first slave device through the first peripheral component interconnect express link, includes:
obtaining data to be processed from a network, and if the data to be processed is compressed data, decompressing the data to be processed to obtain decompressed data; and
based on the bus address space allocated for the first slave device, writing the decompressed data into the storage component of the first slave device through the first peripheral component interconnect express link.

On a second aspect, the present application provides a data processing apparatus, applied to a master field programmable gate array device, and the data processing apparatus includes:
a data to be processed writing module, configured to, based on a bus address space allocated for a first slave device, write data to be processed into a storage component of the first slave device through a first peripheral component interconnect express link, in order that the first slave device processes the data to be processed and obtains result data;
a result data obtaining module, configured to obtain the result data sent by the first slave device; and
a result data forwarding module, configured to determine a destination address of the result data, and if the destination address points to a storage space of a second slave device, write the result data into a storage component of the second slave device through a second peripheral component interconnect express link.

On a third aspect, the present disclosure provides an electronic device including a memory and a processor, wherein:
the memory is configured to store a computer program; and
the processor is configured to execute the computer program to realize the above data processing methods.

On a fourth aspect, the present disclosure provides a non-transitory computer readable storage medium for storing a computer program, wherein the computer program, when executed by a processor, implements the above data processing methods.

It can be seen that the present disclosure is applied to the master field programmable gate array device. Based on the bus address space allocated for the first slave device, the data to be processed is written into the storage component of the first slave device through the first peripheral component interconnect express link, so that the first slave device may process the data to be processed to obtain the result data, then the result data sent by the first slave device is obtained, and the destination address of the result data is determined. If the destination address points to the storage space of the second slave device, the result data is written into the storage component of the second slave device through the second peripheral component interconnect express link. That is, the master field programmable gate array device in the embodiments of the present disclosure allocates a bus address space for the slave device, writes the data to be processed into the storage component of the first slave device through the first peripheral component interconnect express link based on the bus address space allocated for the first slave device, obtains the result data sent by the first slave device, obtained by processing the data to be processed by the first slave device, and when the destination address of the result data points to the storage space of the second slave device, writes the result data into the storage component of the second slave device through the second peripheral component interconnect express link. In this way, through the master field programmable gate array device allocating the bus address space to the slave device, and the communication across nodes between the slave devices is realized. The slave device may be a GPU accelerator card or a field programmable gate array accelerator card.

The advantages of the present application lie in that the coupling between the slave device and the server is reduced, and the communication delay across nodes and the hardware resource overhead thereof may be reduced.

### BRIEF DESCRIPTION OF THE DRAWINGS

In order to more clearly explain technical solutions of the embodiments of the present application or in the prior art, drawings needed to be used in the description of the embodiments or the prior art will be briefly introduced below. Apparently, the drawings in the following description are only the embodiments of the present disclosure. For persons skilled in the art, other drawings may be obtained according to the provided drawings without creative labor.

FIG. 1 is a schematic diagram of GPUDirect P2P data interaction provided by an embodiment of the present application;

FIG. 2 is a schematic diagram of GPUDirect RDMA data interaction provided by an embodiment of the present application;

FIG. 3 is a flowchart of a data processing method provided by an embodiment of the present application;

FIG. 4 is a schematic diagram of a specific slave device provided by an embodiment of the present application;

FIG. 5 is a schematic diagram of a specific master device provided by an embodiment of the present application;

FIG. 6 is a schematic diagram of a mapping relationship of hardware storage resources of a GPU card of a slave device on a 64-bit bus of a master device, provided by an embodiment of the present application;

FIG. 7 is a schematic diagram of a mapping relationship of storage resources on a bus inside a master FPGA device itself, provided by an embodiment of the present application;

FIG. 8 is a schematic diagram of a mapping relationship of storage resources of a plurality of slave devices on a bus of a master device FPGA, provided by an embodiment of the present application;

FIG. 9 is a flow chart of device registration provided by an embodiment of the present application;

FIG. 10 is a schematic structural diagram of a data processing apparatus provided by an embodiment of the present application; and

FIG. 11 is a structural diagram of an electronic device provided by an embodiment of the present application.

### DETAILED DESCRIPTION

In the following, the technical solutions in the embodiments of the present application will be clearly and completely described with reference to the drawings in the embodiments of the present application. Apparently, the described embodiments are only a part of the embodiments of the present application, but not all embodiments. Based on the embodiments in the present application, all other embodiments obtained by persons skilled in the art without creative work belong to the protection scope of the present application.

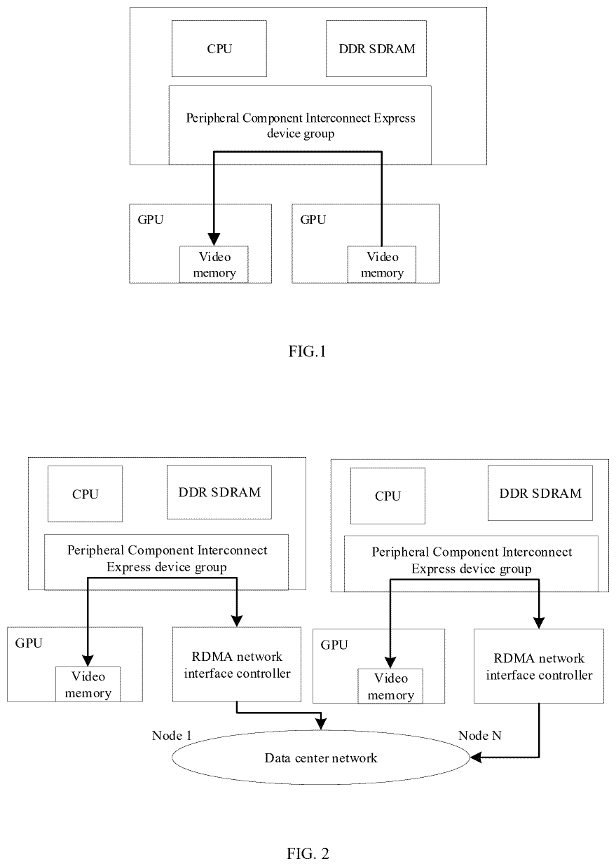

GPUDirect Shared Memory (i.e., direct shared memory) supports a GPU to share memory with a third-party PCIe device through a shared host memory (the memory of the host). GPUDirect P2P (i.e. GPUDirect Peer-to-Peer) is that two GPU devices in the same PCIe Root Complex (root device) domain directly access GPU memories (i.e., video memory of GPU) to each other, and there is no need to copy data into the host memory for transferring between the GPUs. Compared with the GPUDirect Shared Memory scheme, GPUDirect P2P reduces steps of copying data from GPU memory to host memory and from host memory to GPU memory, which reduces data path delay, and improves data transmission efficiency. See FIG. 1, which is a schematic diagram of GPUDirect P2P data interaction provided by the embodiment of the present application, but this scheme is a scheme to realize data interaction of GPU memories in the same single node of server, and the scheme relies on the participation of host CPU or must be in the same PCIe domain, to realize GPU memory data interaction. Among them, the video memory may be GDDR (that is, Graphics Double Data Rate, a kind of high-performance video memory). GPUDirect RDMA (that is, Remote Direct Memory Access) is a technology that uses RDMA-related technologies, physical network cards and transmission networks to realize direct video memory data interaction between GPUs in different nodes, which solves the problems that in such as TCP (i.e., Transmission Control Protocol)/IP (i.e., Internet Protocol) data transmission process of traditional networks, data transmission needs to go through CPU, host cache and other links, resulting in long delay and high CPU occupancy rate, and which realizes the function of directly accessing GPU memories to each other between different nodes through network cards. Referring to FIG. 2, FIG. 2 is a schematic diagram of GPUDirect RDMA data interaction provided by the embodiment of the present application.

GPUDirect P2P technology is developed and realized based on the condition that GPU functions as a PCIe device under the HOST. Communication between a GPU device and other device depends on the participation of the CPU, memory and PCIe Switch (i.e., switch) system of the Host. The GPU device is tightly coupled with the CPU and memory through PCIe, of the server, and communication is limited to the GPU cards in a single node. When GPUDirect P2P technology is used to exchange video memory data between GPUs, it is only limited to direct interaction of video memory data between GPUs in the same PCIe domain through PCIe Chipset. If the exchange is across PCIe domains of two CPUs, it needs the CPU and CPU cache to participate in the data transmission. When the exchange is across CPUs, the interactive delay of video memory data between the GPUs is still very large and CPU overhead is still very large. Although the GPUDirect RDMA technology has used RDMA technology to realize communication of GPU cards across nodes, it needs to run related network protocol software on a high-performance network card and a local server CPU in the same PCIe domain to help the GPU to complete the data transmission across nodes. Among them, the GPU and the server are still tightly coupled through PCIe connection, the GPU cannot run independently of the server, the communication between GPUs across nodes may only be carried out by connecting the network card to the switch, and the communication network topology is not flexible enough, with low packet forwarding efficiency and long communication delay. When deploying a distributed computing system platform based on the above two technologies, a large amount of hardware devices such as CPU, memory and network card of host, are needed, space occupied by racks of a data center is large, and deployment and maintenance costs are high.

At present, communication between GPU cards and traditional FGPA cards across nodes usually depends on the participation of CPU, memory and PCIe Chip set of server, that is, it needs to use tight couple with the server through the PCIe interface bus, and it is difficult to run independently from the host CPU. In this way, the communication delay in the data transmission process is high, and the hardware resource overhead is large. Therefore, the present application provides a technical solution which may reduce communication delay across nodes and the hardware resource overhead thereof.

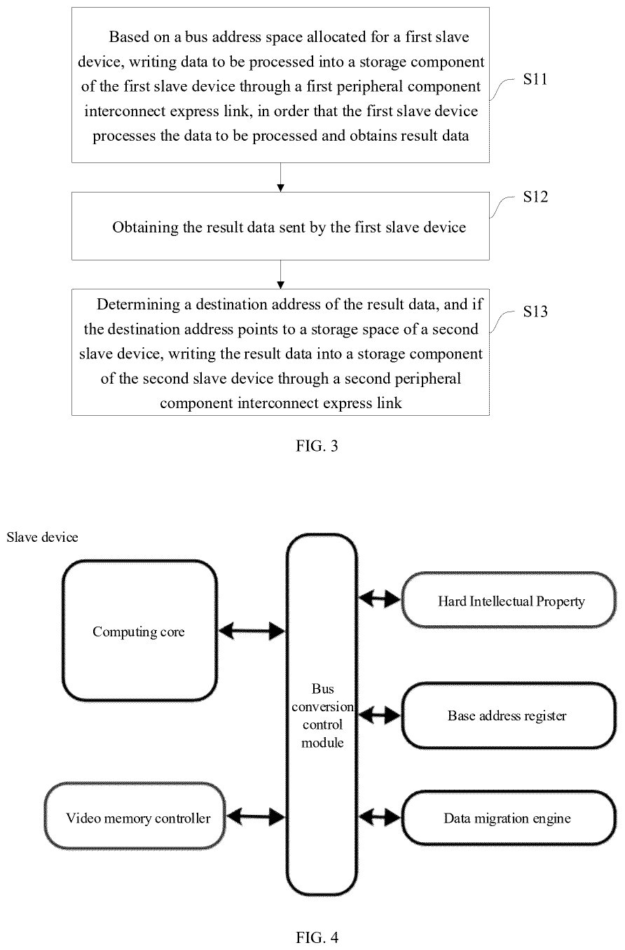

Referring to FIG. 3, the embodiment of the present application discloses a data processing method, which is applied to a master field programmable gate array device, and includes:
step S11: based on a bus address space allocated for a first slave device, writing data to be processed into a storage component of the first slave device through a first peripheral component interconnect express link, in order that the first slave device processes the data to be processed and obtains result data.

In one embodiment, the data to be processed may be obtained from a network, and if the data to be processed is encrypted, decryption is performed to obtain decrypted data; and based on the bus address space allocated for the first slave device, the decrypted data is written into the storage component of the first slave device through the first peripheral component interconnect express link. In another embodiment, the data to be processed may be obtained from the network, and if the data to be processed is compressed, decompression is performed to obtain decompressed data; and based on the bus address space allocated for the first slave device, the decompressed data is written into the storage component of the first slave device through the first peripheral component interconnect express link. In one embodiment, the data to be processed may be obtained and analyzed through a network module i.e., network protocol module, which a general term in the art, specifically an RoCE (RDMA over Converged Ethernet) module, such as a RDMA network interface controller in FIG. 2, and the data to be processed may be decrypted and decompressed through an acceleration core module, i.e., acceleration core, which a general term in the art, to obtain the decompressed data, and then based on the bus address space allocated for the first slave device, the decompressed data may be written into the storage component of the first slave device through the first peripheral component interconnect express link. Among them, the storage component may be GDDR. The data to be processed may be data sent by a remote management control platform, data sent by other master devices, or data sent by other slave devices having network sending function.

It can be understood that the master field programmable gate array device is the master device, and the master device is the field programmable gate array device. The embodiment of the present application may find slave devices in place (“in place” means, the slave devices has been in a standby state for running, for example, a GPU card has been plugged in a slot of the master device) and allocate a bus address space for each slave device in place to complete registration of the devices in place. Moreover, the master device allocates bus address spaces for respective local modules, such as registers or memory in the master device. The slave device allocates bus address spaces for respective modules of the slave device itself based on the bus address space allocated by the master device. Specifically, different bus address spaces of registers and memories and base addresses may be allocated to respective modules. A mapping relationship of storage resources in a slave device on the bus is that: starting from a base address obtained on the master device bus, a configuration space register, BAR registers and GDDR memory resources are arranged in sequence. A mapping relationship of storage resources inside the master device itself on the bus is that: starting from a base address, a configuration space register, a BAR register space and GDDR memory resources are arranged in sequence. The registers and the GDDR memory resources correspond to modules.

In the embodiment of the present application, each of the slave devices may be a general PCIe accelerator card, such as a GPU accelerator card or a field programmable gate array accelerator card. That is, the first slave device is a GPU accelerator card or a field programmable logic gate array accelerator card. The FPGA is a highly programmable heterogeneous chip with multiple components, having abundant hardware resources therein, such as look-up tables, registers, DSP (i.e., Digital Signal Processing) cores, AI (Artificial Intelligence) cores, PCIe HIPs (Hard Intellectual Property), high-speed Serdes (serializer and deserializer) and bus interconnection resources, etc. Users may use these resources to realize various data processing engines, complex bus protocols and network protocols. GPU is a specialized graphics processing chip, which has been widely used in the field of AI computing since its early use in graphics and image processing, and it is also an important computing chip. At present, GPU, as a kind of PCIe device, is plugged in a slot of server of data center, and often communicates with the host and other nodes through PCIe. Although there is flexible and high-speed NVLink (a kind of bus and communication protocol) communication technology between GPUs, this technology is limited to communication of GPUs in a single node, and the GPUs cannot be directly connected with a network of an external data center. RoCE is a reliable transmission protocol that uses a converged Ethernet to realize direct access of memory between local and remote, and it may reduce overhead of CPU of the HOST during data migration, and the CPU only needs to be responsible for management work of control level.

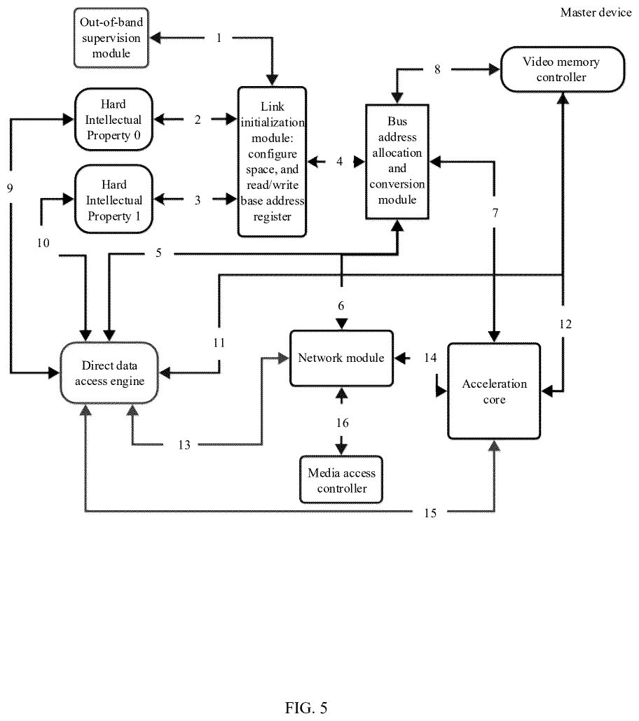

In a specific embodiment, the slave device is directly connected to the PCIe slot of the master device through a PCIe link and an SMBUS (i.e., System Management Bus) bus. The master FPGA device, inside itself, is provided with a plurality of PCIe HIP hard cores in PCIe rootcomplex mode, an out-of-band supervision module, a link initialization module, an address (i.e., bus address) allocation and conversion module, a GDDR controller (namely, a video memory controller), a DMA (namely, a direct data access) engine, i.e., DMA engine module, an RoCE protocol stack (namely, a network module), a MAC controller (namely, a media access controller) and an acceleration core, i.e., acceleration core module. A PCIe-based GPU slave device chip, inside itself, usually has a computing core, a GDDR controller, a PCIe HIP, a BAR (that is, a base address register) and a Copy (data migration) engine, etc., and there is further an out-of-band management I2C (that is, Inter-Integrated Circuit, a kind of bidirectional two-wire synchronous serial bus) channel on the board thereof, such as a bus conversion control module in FIG. 4. For example, referring to FIG. 4, FIG. 4 is a schematic diagram of a specific slave device provided by an embodiment of the present application. Referring to FIG. 5, FIG. 5 is a schematic diagram of a specific master device provided by an embodiment of the present application.

Among them, the master device of the present disclosure specifically includes the following modules: the out-of-band supervision module, which connects the slave devices through a I2C bus, and reads and writes registers of the slave devices to obtain state data of the slave devices, so as to monitor and manage the slave devices; two PCIe HIPs, which work in the PCIe rootcomplex mode, docking with PCIe HIPs of the slave devices, wherein it shall be pointed out that a PCIe HIPO (that is, hard-core Intellectual Property 0) and a PCIe HIP 1 (that is, hard-core Intellectual Property 1) are shown as examples, but the PCIe HIPs may be expanded according to a number of the slave devices actually in place; the link initialization module, which converts reading and writing commands of the configuration space register into a standard PCIe TLP (that is, Transaction Layer Packet) packet to complete enumeration of PCIe of the slave devices and configuration of the configuration space register; a bus address allocation and conversion module, which is connected with control state register interfaces of respective modules, and the GDDR controller and the DMA engine, and allocates different bus address spaces of registers and memories and base addresses to the respective modules; a network protocol module supporting RoCEv2, which has a function of remote direct memory data migration with heterogeneous devices in other nodes, and ensures high bandwidth and reliable network communication between the FPGA card, and the remote management control platform and other FPGA cards; a MAC controller module, which is mainly responsible for sending and receiving network data packets; the GDDR controller, which is a kind of high-performance controller for video memory, wherein the controlled video memory has higher working frequency, smaller calorific value and volume; and the DMA engine, which receives and processes load data in TLP packets from the slave devices, buffers the load data to the GDDR of the master device, or sends the load data to the acceleration core of the master device for processing, or sends the load data to other node devices through an RoCE network. Similarly, data from the GDDR of the master device, the acceleration core of the master device, or the RoCE network, may also be sent to the slave devices through the DMA engine and the PCIe HIP. The acceleration core may be an algorithm core, such as encryption and decryption, compression and decompression, etc., realized by a part of logic resources hardware of the FPGA, and may process data from the DMA of the slave devices, data form the RoCE network, and data in the GDDR of local. Among them, reference signs 1 to 16 in FIG. 5 represent transmission paths, and for example, 1 is the transmission path between the out-of-band supervision module and the link initialization module.

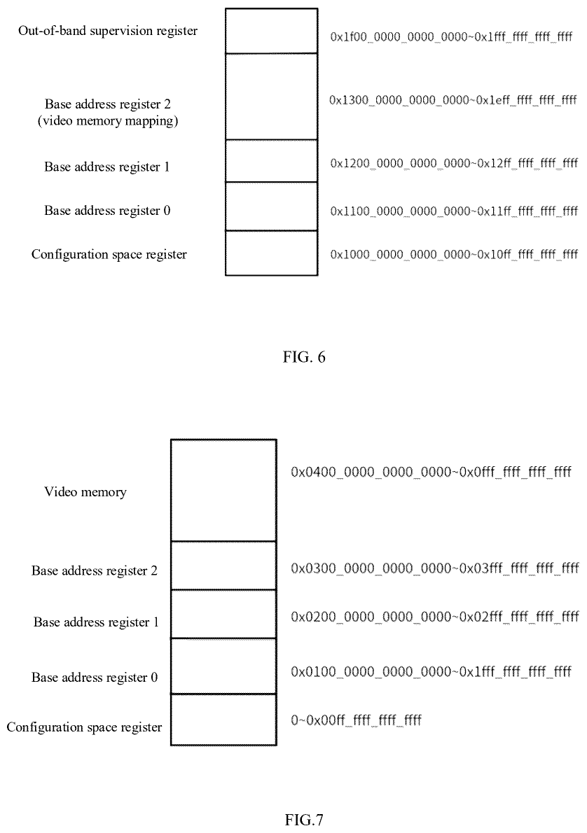

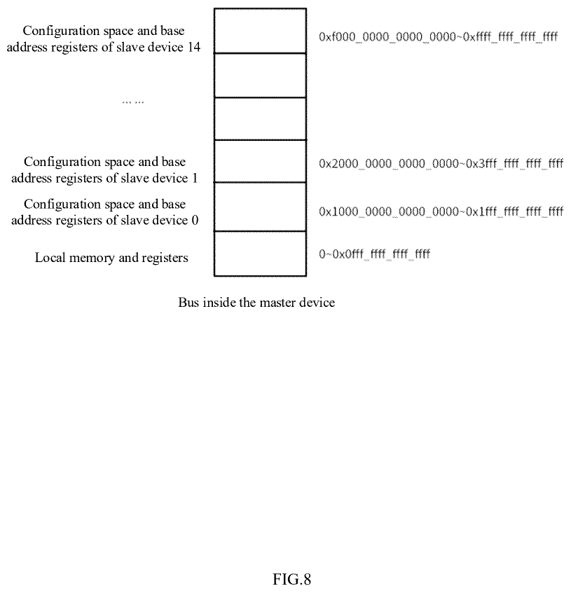

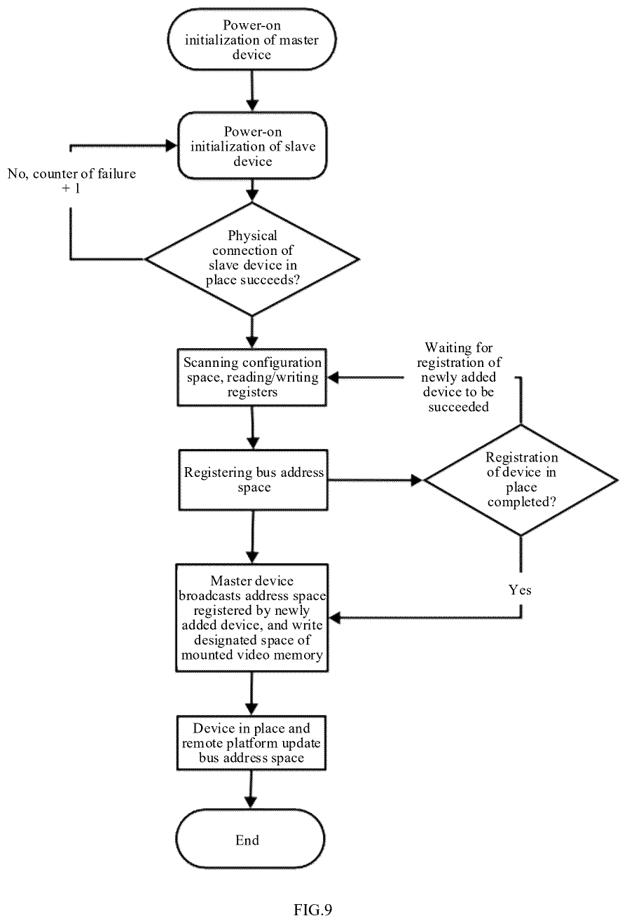

Referring to FIG. 6, FIG. 6 is a schematic diagram of a mapping relationship of hardware storage resources of a GPU card of a slave device on a 64-bit bus of a master device, provided by an embodiment of the present application, in which the configuration space register, the BAR registers and the GDDR memory resources are arranged in sequence, starting from the base address 0x1000_0000_0000_0000_0000 obtained on the master device bus. As shown in FIG. 7, FIG. 7 is a schematic diagram of a mapping relationship of storage resources on a bus inside a master FPGA device itself, provided by an embodiment of the present application. Among them, starting from the base address 0x0, the configuration space register, the BAR register space and the GDDR memory resources are sequentially arranged. Referring to FIG. 8, FIG. 8 is a schematic diagram of a mapping relationship of storage resources of a plurality of slave devices on a bus of a master device FPGA, provided by an embodiment of the present application, wherein, from low to high of the bus addresses, a local resource mapping of the master device and resource mappings of respective slave devices are arranged in sequence.

Further, referring to FIG. 9, FIG. 9 is a flow chart of device registration provided by an embodiment of the present application. Taking the GPU card of the slave device in the node as an example, a process of system power-on initialization, registration of the slave device, PCIe configuration space initialization of the slave device and storage resource mapping of the slave device, is as follows: power-on initialization of the master device, triggered by the master device; power-on initialization of the slave device, wherein the slave device may be a GPU card or an FPGA card; determining whether a link (i.e., a physical connection) with a slave device in place is succeeded, that is, whether a physical layer connection is established with the slave device in place; if the physical layer connection with the slave device in place fails, counting a number of failures; and if the physical layer connection with the slave device in place is succeeded, performing scanning for configuration space and reading and writing of the registers to obtain required memory sizes (i.e., space size) of the BAR registers; then registering a bus address space; then broadcasting the bus address space registered by the slave device newly added, that is, the allocated bus address space; and writing a designated space of mounted GDDR into the bus address space, then the bus address spaces of the slave device in place and the remote platform are updated.

Further, in the embodiment of the present application, an interrupt packet may be sent to notify the first slave device to process the data to be processed. In a specific embodiment, based on a mapping relationship of registers in the first slave device on the bus of the master field programmable gate array device, the interrupt data packet may be written into a designated register of the first slave device, so as to notify the first slave device to process the data to be processed.

Still referring to FIG. 3, the data processing method further includes:
step S12: obtaining the result data sent by the first slave device; and
step S13: determining a destination address of the result data, and if the destination address points to a storage space of a second slave device, writing the result data into a storage component of the second slave device through a second peripheral component interconnect express link. Among them, the second slave device is a GPU accelerator card or a field programmable logic gate array accelerator card.

Further, if the destination address points to the storage space of the local device, the result data is written into the local storage component.

In addition, if the destination address points to a network module of local, sending the result data to the network module, and sending the result data to a network by the network module.

Further, if the destination address points to an acceleration core module of local, sending the result data to the acceleration core module, and calling a preset processing logic through the acceleration core module to process the result data.

Moreover, in a specific embodiment, a data processing type may be determined based on a descriptor corresponding to the result data. Correspondingly, calling the preset processing logic through the acceleration core module to process the result data, includes: calling the preset processing logic corresponding to the data processing type through the acceleration core module to process the result data.

Among them, if the data processing type is encryption processing, calling an encryption processing logic through the acceleration core module to encrypt the result data; if the data processing type is compression processing, calling a compression processing logic by the acceleration core module to compress the result data; and if the data processing type is compression processing first and then encryption processing, calling the compression processing logic to compress the result data to obtain compressed data, and calling the encryption processing logic to encrypt the compressed data, through the acceleration core module.

That is, in the embodiment of the present application, the descriptor describes a next operation for the result data, and the result data may be forwarded and the next operation may be performed on the result data, based on the descriptor and the destination address.

In one embodiment, after sending the interrupt packet to notify the first slave device, the embodiment of the present application may also read the result data from the storage component of the first slave device when a notification sent by the first slave device is obtained; wherein the result data is stored by the first slave device into the storage component of the first slave device. That is, after the first slave device processes the data to be processed and obtains the result data, the result data is stored into the storage component of the first slave device by the first slave device. Among them, a direct data access engine is used to read the result data from the storage component of the first slave device.

Moreover, after reading the result data from the storage component of the first slave device, the result data may be cached to the storage component of the local device. Further, the acceleration core module is used to compress the result data to obtain compressed data, and the compressed data is encrypted to obtain encrypted data. Then the encrypted data is encapsulated by the network module and sent to other nodes through an optical network.

That is, in specific embodiments, after the slave device obtains the result data, the slave device may notify the master device to read the result data from the slave device, or send the result data to the master device.

It can be understood that in the embodiments of the present application, the master device initializes and registers the PCIe slave device to complete the address mapping of the storage resources. In addition, the master device may monitor and manage the slave device and the master device through the out-of-band supervision module formed by the I2C channel. It is converted into a standard format TLP packet from an internal bus interface. In addition, the slave device and the master device have DMA controllers, so when one side performs a DMA operation, it does not influence on a normal DMA operation of the other side. When the FPGA of the master device communicates with devices of other nodes through the RoCE network, it performs encryption, decryption, compression and decompression on local to ensure data communication safety, reduce communication traffic and reduce communication delay. Sources or destinations of data processed by the DMA engine of the master device may be slave device cache, local cache, or the data is come from the RoCE module or the acceleration core module, or the data is sent to the RoCE module or the acceleration core module for reprocessing, and different descriptors may be used for labeling and distinguishing. Further, with reference to FIG. 5, in the master device provided by the present application, the DMA engine, the acceleration core and the RoCE module support a variety of combinations of data stream processing, for example, several realizable data processing flows are listed as follows.
1. After the data to be processed is parsed from RoCE (network module), the data is decrypted by the acceleration core and stored into the GDDR of the master device through path 12, then read out from the GDDR and decompressed by the acceleration core. After decompression, the data is sent to the PCIe HIPO through the DMA engine and based on paths 11 and 9, and written into the GDDR of slave device 0 (a GPU card) corresponding to PCIe HIPO, and interrupt TLP packets are sent to notify the GPU card to process. Specifically, the DMA engine sends the interrupt TLP packets, the interrupt TLP packets are packaged by the bus address allocation and conversion module and the link initialization module in sequence, to obtain a write packet (i.e., write operation packet) for a designated register, the write packet is written into the designated register of the GPU card, which passes through paths 5, 4 and 2 in FIG. 5 in sequence.
2. After the GPU card of the slave device 0 completes processing the data, a Doorbell register is written to notify the DMA engine in the master FPGA device to read a result in the GDDR of the GPU card of the slave device 0 (through paths 2, 4 and 5 in FIG. 5 in sequence). After the DMA engine obtains the data, the data is cached in the GDDR of the master device, then compressed by the acceleration core, and then read and forwarded to the acceleration core for encryption. After the encryption is completed, the data is sent to the RoCE module for encapsulation and sent to other nodes through the optical network (sent to other nodes through the media access controller through path 16).
3. The DMA engine may perform the next operation according to the descriptor and the destination address of the data packet sent from the GPU card of the slave device 0. If the address points to the storage space of the slave device 1, related information of a TLP header is modified and the data packet is forwarded to the slave device 1 through the DMA engine. Specifically, the data is obtained through the PCIE HIPO and forwarded to the slave device 1 through the PCIE HIPO (through paths 9 and 10). If the address points to the storage space of the local device, the data is written into the GDDR of the local storage through the DMA engine (through paths 9 and 11). If the address points to the RoCE or the acceleration core, the packets are sent to the RoCE module by the DMA engine to be packaged and are sent to the network (through paths 9, 13 and 16), or packets are sent to the acceleration core for further processing (through paths 9 and 15).

It should be pointed out that in the embodiments of the present application, the slave devices may all use FPGA acceleration cards, or may partially use GPU acceleration cards and partially use FPGA acceleration cards, thereby forming a heterogeneous acceleration system. When using GPU cards or FPGA cards, the GPU card or FPGA card is independent of a traditional Host motherboard, and, as an endpoint (slave device) device, communicates directly with the FPGA of the master device through a PCIe link, completing enumeration, configuration and initialization of the GPU card or FPGA card as a slave device, which may reduce coupling degree between the GPU card or FPGA card and the server. The GPU or FPGA resources does not rely on CPU, memory and PCIe related chipset of HOST, which reduces indirect overhead cost of these resources when users use the GPU or FPGA resources. The communication between devices in the present application adopts mature and universal PCIe link and direct communication based on protocols supported by the PCIe link, which has high flexibility and lower communication delay. In the present application, the FPGA of a single master device may support connection with a plurality of GPU cards or FPGA cards through PCIe, and all storage resources (in-band BAR registers and in-band caches) on each slave device may be mapped on an interconnection bus inside the master device, so that the master device may schedule and use the resources of the slave devices. In the present application, through the out-of-band supervision module, the FPGA of the master device may communicate with the slave device through an out-of-band I2C channel, to monitor and manage states of the slave device. Data may be suffered a secondary treatment (such as encryption, decryption, compression or decompression) in the FPGA card before being sent to the GPU card and after being output from the GPU card, and then the data is sent to a next processing module or sent out through an optical port, thus improving data transmission security and reducing communication traffic and communication delay. In the present application, the DMA engine module may forward the TLP packets to other slave devices according to PCIe TLP packet addresses, or store the TLP packets in the GDDR of the master device, or the TLP packets may be encapsulated through the RoCE protocol and forwarded to other node devices through the optical network.

In this way, the slave devices are connected through a plurality of PCIe interfaces in the master device (which may be an FPGA accelerator card), so that the coupling degree between PCIe-based slave devices and a server motherboard is reduced, the initialization, registration and address mapping processes of the slave device are flexibly completed, and a plurality of modules, in the master device and the slave device, are connected through the DMA engine for flexible data processing, so that the communication delay between devices is effectively reduced, communication expansion ability with neighboring nodes is greatly improved, and the deployment cost of heterogeneous systems using PCIe-based devices is greatly reduced, which provides a new computing acceleration platform for distributed applications. It may solve the problems of long delay, dependence on the participation of server CPU, memory and PCIe Chipset, and high hardware resource overhead in the process of data transmission, in communication between GPUs across nodes in GPU-based AI training in modern data centers.

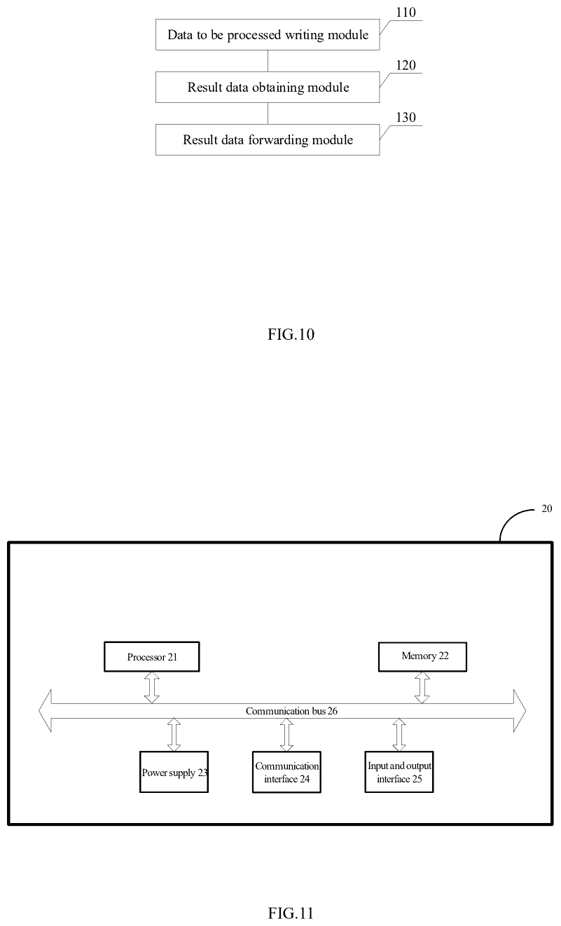

Referring to FIG. 10, an embodiment of the present application discloses a data processing apparatus, which is applied to the master field programmable gate array device, and includes:
a data to be processed writing module 110, configured to, based on the bus address space allocated for the first slave device, write the data to be processed into the storage component of the first slave device through the first peripheral component interconnect express link, in order that the first slave device processes the data to be processed and obtains result data;
a result data obtaining module 120, configured to obtain the result data sent by the first slave device; and
a result data forwarding module 130, configured to determine the destination address of the result data, and if the destination address points to the storage space of the second slave device, write the result data into the storage component of the second slave device through the second peripheral component interconnect express link.

It can be seen that the embodiment of the present application is applied to the master field programmable gate array device. Based on the bus address space allocated for the first slave device, the master field programmable gate array device writes the data to be processed into the storage component of the first slave device through the first peripheral component interconnect express link, so that the first slave device may process the data to be processed and obtains the result data. Then the master field programmable gate array device obtains the result data sent by the first slave device. Then the master field programmable gate array device determines the destination address of the result data. If the destination address points to the storage space of the second slave device, the master field programmable gate array device writes the result data into the storage component of the second slave device through the second peripheral component interconnect express link. That is, the master field programmable gate array device in the embodiment of the present application allocates the bus address space for the slave device, writes the data to be processed into the storage component of the first slave device through the first peripheral component interconnect express link based on the bus address space allocated for the first slave device, obtains the result data, obtained by processing the data to be processed, sent by the first slave device, and writes the result data into the storage component of the second slave device through the second peripheral component interconnect express link when the destination address of the result data points to the storage space of the second slave device. In this way, through the master field programmable gate array device, the bus address space is allocated to the slave device, and the communication between the slave devices across nodes is realized. The slave device may be the GPU accelerator card or the field programmable gate array accelerator card, thereby, the coupling between the slave device and the server is reduced, and the communication delay and hardware resource overhead across nodes may be reduced.

The apparatus further includes an interrupt notification module, configured to send the interrupt data packet to notify the first slave device to process the data to be processed.

Among them, the interrupt notification module is specifically configured to, based on the mapping relationship of the registers in the first slave device on the bus of the master field programmable logic gate array device, write the interrupt data packet into the designated register of the first slave device, so as to notify the first slave device to process the data to be processed.

Among them, the result data forwarding module 130 is further configured to, if the destination address points to the storage space of the local device, write the result data into the local storage component; if the destination address points to the network module of local, send the result data to the network module and sent the result data to the network through the network module; and if the destination address points to the acceleration core module of local, send the result data to the acceleration core module, and call the preset processing logic through the acceleration core module to process the result data.

Moreover, the result data forwarding module 130 is further configured to determine the data processing type based on the descriptor corresponding to the result data; and call the preset processing logic corresponding to the data processing type through the acceleration core module to process the result data. Specifically, if the data processing type is the encryption processing, call the encryption processing logic by the acceleration core module to encrypt the result data; if the data processing type is the compression processing, call the compression processing logic by the acceleration core module to compress the result data; and if the data processing type is the compression processing first and then the encryption processing, call the compression processing logic to compress the result data to obtain the compressed data, and call the encryption processing logic to encrypt the compressed data, by the acceleration core module.

Further, the apparatus includes a data reading module, specifically configured to read the result data from the storage component of the first slave device when obtaining the notification sent by the first slave device; wherein the result data is stored into the storage component of the first slave device by the first slave device.

In addition, the apparatus further includes a data caching module, configured to, after reading the result data from the storage component of the first slave device, cache the result data to the storage component of the local device. Further, the apparatus includes the acceleration core module, configured to compress the result data to obtain the compressed data, and encrypt the compressed data to obtain the encrypted data; and the network module, configured to encapsulate the encrypted data and send encapsulated encrypted data to other nodes through the optical network.

Among them, the data reading module is specifically configured to read the result data from the storage component of the first slave device by using the direct data access engine.

In addition, the apparatus further includes a slave device registration and bus address space allocation module, configured to find slave devices in place, and allocate the bus address space for each slave device in place to complete the registration of the devices in place; and allocate the bus address spaces for respective local modules.

The first slave device is the GPU accelerator card or the field programmable gate array accelerator card, and the second slave device is the GPU accelerator card or the field programmable gate array accelerator card.

In one embodiment, the data to be processed writing module 110 is specifically configured to obtain the data to be processed from the network, and if the data to be processed is encrypted data, decrypt the data to be processed to obtain the decrypted data; and based on the bus address space allocated for the first slave device, write the decrypted data into the storage component of the first slave device through the first peripheral component interconnect express link.

In another embodiment, the data to be processed writing module 110 is specifically configured to obtain data to be processed from the network, and if the data to be processed is compressed data, decompress the data to be processed to obtain decompressed data; and based on the bus address space allocated for the first slave device, write the decompressed data into the storage component of the first slave device through the first peripheral component interconnect express link.

Referring to FIG. 11, an embodiment of the present application discloses an electronic device 20, which includes a processor 21 and a memory 22; wherein the memory 22 is configured to store a computer program; and the processor 21 is configured to execute the computer program to realize the data processing methods disclosed in the above embodiments.

For specific processes of the above data processing methods, please refer to corresponding contents disclosed in the above embodiments, and will not be repeated here.

Moreover, the memory 22, as a carrier of resource storage, may be read-only memory, random access memory, magnetic disk or optical disk, and a storage mode may be volatile storage or permanent storage.

In addition, the electronic device 20 further includes a power supply 23, a communication interface 24, an input and output interface 25 and a communication bus 26. Among them, the power supply 23 is configured to provide working voltages for respective hardware devices on the electronic device 20. The communication interface 24 is able to create a data transmission channel between the electronic device 20 and external devices, and communication protocols it follows is any communication protocol that may be applied to the technical solution of the present application, so it is not specifically limited here. The input and output interface 25 is configured to acquire data input from outside or output data to the outside, and a specific interface type thereof may be selected according to needs of specific applications, and is not specifically limited here.

Further, an embodiment of the present application further discloses a non-transitory computer readable storage medium for storing a computer program, wherein the computer program, when executed by a processor, realizes the data processing methods disclosed in the above embodiments.

For the specific processes of the above data processing methods, please refer to the corresponding contents disclosed in the above embodiments, and will not be repeated here.

The respective embodiments in the specification are described in a progressive way, and each embodiment focuses on differences from other embodiments, so the same or similar parts between the respective embodiments may only be referred to each other. As for the devices disclosed in the embodiments, because they correspond to the methods disclosed in the embodiments, the descriptions thereof are relatively simple, and relevant points may only be described in the method parts.

The steps of methods or algorithms described in connection with the embodiments disclosed herein may be directly implemented in hardware, a software module executed by a processor, or a combination of the two. The software module may be placed in random access memory (RAM), internal memory, read-only memory (ROM), electrically programmable ROM, electrically erasable programmable ROM, register, hard disk, removable disk, CD-ROM, or any other storage medium known in the technical field.

A data processing method, an apparatus, a device and a medium provided by the present application are described in detail above. In this paper, principles and implementations of the present application are expounded by using specific examples. The description of the above examples is only used to help understand the methods and core ideas of the present application. At the same time, for persons skilled in the art, according to the idea of the present application, there will be changes in the specific implementations and application scopes. To sum up, the contents of the specification should not be understood as limitations to the present application.

1. A data processing method, wherein the data processing method is applied to a master field programmable gate array device, and comprises:
based on a bus address space allocated for a first slave device, writing data to be processed into a storage component of the first slave device through a first peripheral component interconnect express link, in order that the first slave device processes the data to be processed and obtains result data;
obtaining the result data sent by the first slave device; and
determining a destination address of the result data, and in response to that the destination address points to a storage space of a second slave device, writing the result data into a storage component of the second slave device through a second peripheral component interconnect express link;
wherein the data processing method further comprises:
in response to that the destination address points to a storage space of a local device, writing the result data into a local storage component;
in response to that the destination address points to a network module of local, sending the result data to the network module and sending the result data to a network through the network module;
in response to that the destination address points to an acceleration core module of local, sending the result data to the acceleration core module, and calling a preset processing logic by the acceleration core module to process the result data;
wherein the data processing method further comprises:
finding slave devices in place, and allocating a bus address space for each slave device in place, to complete registration of the devices in place, and to make the slave device allocate bus address spaces for modules of the slave device based on the bus address space allocated by the master device; and
allocating bus address spaces for respective local modules;
wherein the first slave device is a GPU accelerator card or a field programmable gate array accelerator card, and the second slave device is a GPU accelerator card or a field programmable gate array accelerator card;
wherein a field programmable gate array of a single master device supports connection with a plurality of GPU accelerator cards or field programmable gate array cards through peripheral component interconnect express (PCIe), and all storage resources on each slave device are mapped on an interconnection bus inside the master device.

2. The data processing method according to claim 1, wherein, after based on the bus address space allocated for the first slave device, writing the data to be processed into the storage component of the first slave device through the first peripheral component interconnect express link, the data processing method further comprises:
sending an interrupt data packet to notify the first slave device to process the data to be processed.

3. The data processing method according to claim 2, wherein sending the interrupt data packet to notify the first slave device to process the data to be processed, comprises:
based on a mapping relationship of registers in the first slave device on a bus of the master field programmable logic gate array device, writing the interrupt data packet into a designated register of the first slave device, so as to notify the first slave device to process the data to be processed.

4-6. (canceled)

7. The data processing method according to claim 6, wherein the data processing method further comprises:
determining a data processing type based on a descriptor corresponding to the result data; and
calling the preset processing logic through the acceleration core module to process the result data, comprises: calling the preset processing logic corresponding to the data processing type through the acceleration core module to process the result data.

8. The data processing method according to claim 7, wherein calling the preset processing logic corresponding to the data processing type through the acceleration core module to process the result data, comprises:
in response to that the data processing type is encryption processing, calling an encryption processing logic through the acceleration core module to encrypt the result data;
in response to that the data processing type is compression processing, calling a compression processing logic through the acceleration core module to compress the result data; and
in response to that the data processing type is the compression processing first and then the encryption processing, calling the compression processing logic to compress the result data to obtain compressed data, and calling the encryption processing logic to encrypt the compressed data, through the acceleration core module.

9. The data processing method according to claim 12, wherein, after sending the interrupt data packet to notify the first slave device, the data processing method further comprises:
reading the result data from the storage component of the first slave device when a notification sent by the first slave device is obtained;
wherein the result data is stored into the storage component of the first slave device by the first slave device.

10. The data processing method according to claim 9, wherein, after reading the result data from the storage component of the first slave device, the data processing method further comprises:
caching the result data to a storage component of a local device.

11. The data processing method according to claim 10, wherein the data processing method further comprises:
compressing the result data by using the acceleration core module to obtain compressed data, and encrypting the compressed data to obtain encrypted data.

12. The data processing method according to claim 11, wherein, after encrypting the compressed data to obtain the encrypted data, the data processing method further comprises:
encapsulating the encrypted data by using a network module and sending encapsulated encrypted data to other nodes through an optical network.

13. The data processing method according to claim 9, wherein reading the result data from the storage component of the first slave device, comprises:
reading the result data from the storage component of the first slave device by using a direct data access engine.

14-15. (canceled)

16. The data processing method according to claim 1, wherein, based on the bus address space allocated for the first slave device, writing data to be processed into the storage component of the first slave device through the first peripheral component interconnect express link, comprises:
obtaining data to be processed from a network, and in response to that the data to be processed is encrypted data, decrypting the data to be processed to obtain decrypted data; and
based on the bus address space allocated for the first slave device, writing the decrypted data into the storage component of the first slave device through the first peripheral component interconnect express link.

17. The data processing method according to claim 1, wherein, based on the bus address space allocated for the first slave device, writing data to be processed into the storage component of the first slave device through the first peripheral component interconnect express link, comprises:
obtaining data to be processed from a network, and in response to that the data to be processed is compressed data, decompressing the data to be processed to obtain decompressed data; and
based on the bus address space allocated for the first slave device, writing the decompressed data into the storage component of the first slave device through the first peripheral component interconnect express link.

18. (canceled)

19. An electronic device, wherein the electronic device comprises a memory and a processor, wherein:
the memory is configured to store a computer program; and
the processor is configured to execute the computer program to realize the data processing method according to claim 1.

20. A non-transitory computer readable storage medium, wherein the non-transitory computer readable storage medium is for storing a computer program, wherein the computer program, when executed by a processor, realizes the data processing method according to claim 1.

21. The data processing method according to claim 1, wherein, the master field programmable gate array device is a master device, the slave device allocates bus address spaces for modules of the slave device based on the bus address space allocated by the master device, and the modules of the slave device comprise registers and graphics double data rate (GDDR) memory resources.

22. The data processing method according to claim 21, wherein the slave device allocates bus address spaces for modules of the slave device based on the bus address space allocated by the master device comprises: different bus address spaces of registers and memories and base addresses are allocated to the modules of the slave device.

23. The data processing method according to claim 1, wherein the data to be processed is data sent by a remote management control platform, data sent by other master devices, or data sent by other slave devices having network sending function.

24. The data processing method according to claim 3, wherein the mapping relationship is that: starting from a base address obtained on a master device bus, a configuration space register, base address registers and GDDR memory resources are arranged in sequence.
